(19) United States
(12) Patent Application Publication
(10) Pub. No.: US 2014/0146344 A1
(43) Pub. Date: May 29, 2014

(54) DEVICE, INFORMATION PROCESSING SYSTEM, AND CONTROL METHOD THEREOF

(71) Applicant: Canon Kabushiki Kaisha, Tokyo (JP)

(72) Inventor: Akihiro Mitsui, Kawasaki-shi (JP)

(73) Assignee: Canon Kabushiki Kaisha, Tokyo (JP)

(21) Appl. No.: 14/088,260

(22) Filed: Nov. 22, 2013

(30) Foreign Application Priority Data
Nov. 27, 2012 (JP) 2012-258558

(51) Int. Cl. H04N 1/32; G06F 21/60; G06K 15/00

(52) U.S. Cl. CPC H04N 1/32117; G06K 15/4095; G06F 21/608
USPC 358/1.14

(57) ABSTRACT

A device includes a notification unit configured to notify an information processing apparatus of an execution instruction for accessing the device, a reception unit configured to receive a fax address corresponding to drawing data from the information processing apparatus as a response to the notification of the execution instruction by the notification unit, and a transmission unit configured to transmit a fax data based on the fax address and the drawing data.

### BACKGROUND

1. Field of the Disclosure

Aspects of the present invention generally relate to a technique for communicating with an external apparatus using a network.

2. Description of the Related Art

Japanese Patent Application Laid-Open No. 2001-318779 discusses processing performed by a printer driver in which, in order to request a user to input a password when printing is performed, a dialog is displayed to wait user's input and then confidential printing is performed using the input value

When the confidential printing is performed, even if the technique described in Japanese Patent Application Laid-Open No. 2001-318779 is used, an information processing apparatus alone may not be able to voluntarily prompt the user to input user input information when the printing is performed. In such a case, when the printing is performed, since the information processing apparatus cannot prompt the user to input the user input information, a device cannot acquire the user input information required to output drawing data.

In addition to the confidential printing, the information processing apparatus alone may not be able to voluntarily prompt the user to input required user input information when department management printing or fax transmission is performed.

This specification describes a method by which the information processing apparatus can prompt the user to input user input information by acquiring a notification from a device, even when the information processing apparatus alone cannot voluntarily prompt the user to input the user input information when output is performed based on drawing data.

### SUMMARY

According to an aspect of the present invention, a device includes a notification unit configured to notify an information processing apparatus of an execution instruction for accessing the device, a reception unit configured to receive a fax address corresponding to drawing data from the information processing apparatus as a response to the notification of the execution instruction by the notification unit, and a transmission unit configured to transmit a fax data based on the fax address and the drawing data.

Further features of the present invention will become apparent from the following description of exemplary embodiments with reference to the attached drawings.

### BRIEF DESCRIPTION OF THE DRAWINGS

FIG. 1 is a block diagram of hardware and software of a computer system.

FIG. 2 illustrates a configuration of a network to which clients, a server, and a printer are connected.

FIG. 3 is a block diagram of a v4 driver print processing system.

FIG. 4 is a block diagram of a printer.

FIG. 5 is an example of a print ticket in an extensible markup language (XML) format, which is used for print setting in the v4 driver print processing system.

FIG. 6 illustrates a start menu of an operating system (OS).

FIG. 7 is a print dialog of an application.

FIG. 8 is a flowchart when a printer driver generates a print job for fax transmission.

FIG. 9 is a flowchart when a printer receives the print job.

FIG. 10 illustrates an XML of a print job status event in Web Services on Devices (WSD).

FIG. 11 is a flowchart when a printer extension receives a WSD event.

FIG. 12 illustrates a notification displayed by an OS.

FIG. 13 is a flowchart illustrating an operation of a printer extension activated with the notification.

FIG. 14 is a flowchart illustrating a fax operation by a printer connected via a web browser.

FIGS. 15A, 15B, and 15C respectively illustrate a log-in screen, a job list, and a fax address list on a printer's web page.

FIG. 16 is a user interface for a printer extension.

FIG. 17 is a flowchart of confidential printing when an event is specified in printer job language (PJL) illustrated in FIG. 8.

FIG. 18 illustrates an operation performed using a single sign-on system.

FIG. 19 is a flowchart illustrating an operation of confidential printing by a printer connected via a web browser.

FIG. 20 illustrates a confidential printing screen of a printer's web page.

### DESCRIPTION OF THE EMBODIMENTS

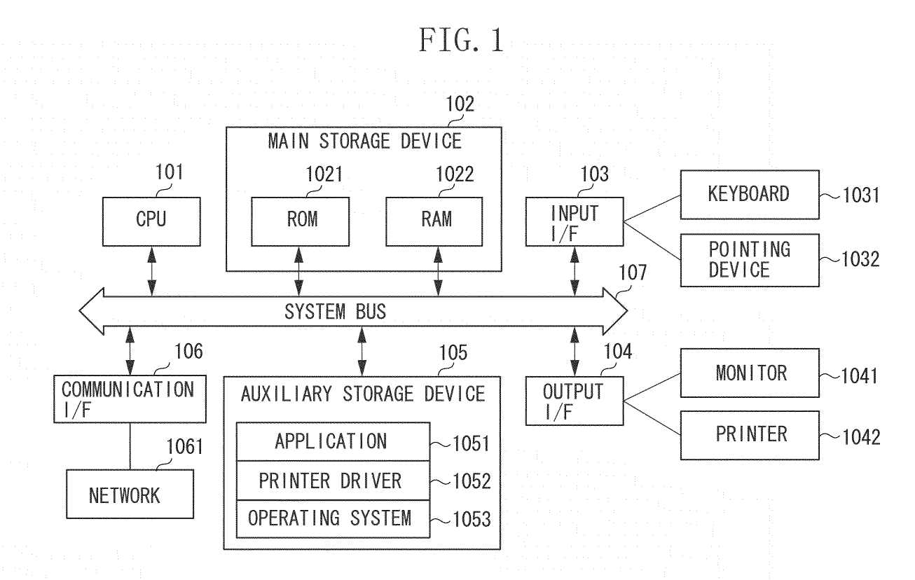

A first exemplary embodiment of the present invention will be described below. FIG. 1 is a block diagram of an information processing apparatus, such as clients 201 and 202 and a server 203 described later. Unless otherwise specified, as long as a function according to the exemplary embodiment is performed, the exemplary embodiment can be applied to any of a standalone system, a system including a plurality of devices, and a system connected via a network to perform processing.

A central processing unit (CPU) 101 controls the whole of the apparatus according to a program stored in a read only memory (ROM) 1021 or a random access memory (RAM) 1022 of a main storage device 102, or an auxiliary storage device 105. The RAM 1022 is also used as a work area when the CPU 101 executes various types of processing. The auxiliary storage device 105 stores an application 1051 and an OS 1053. Input devices including a keyboard 1031 and a pointing device 1032 such as a mouse and a touch panel are used when a user gives various types of instructions to a computer via an input interface (I/F) 103. An output I/F 104, which is an interface to output data to the outside, outputs data to an output device such as a monitor 1041 and a printer 1042. The printer 1042 may be connected via, in addition to a local in/out (I/O) directly connected with, a network 1061 connected via a communication I/F 106. Further, data is transmitted or received between the I/Fs and the modules via a common data system bus 107.

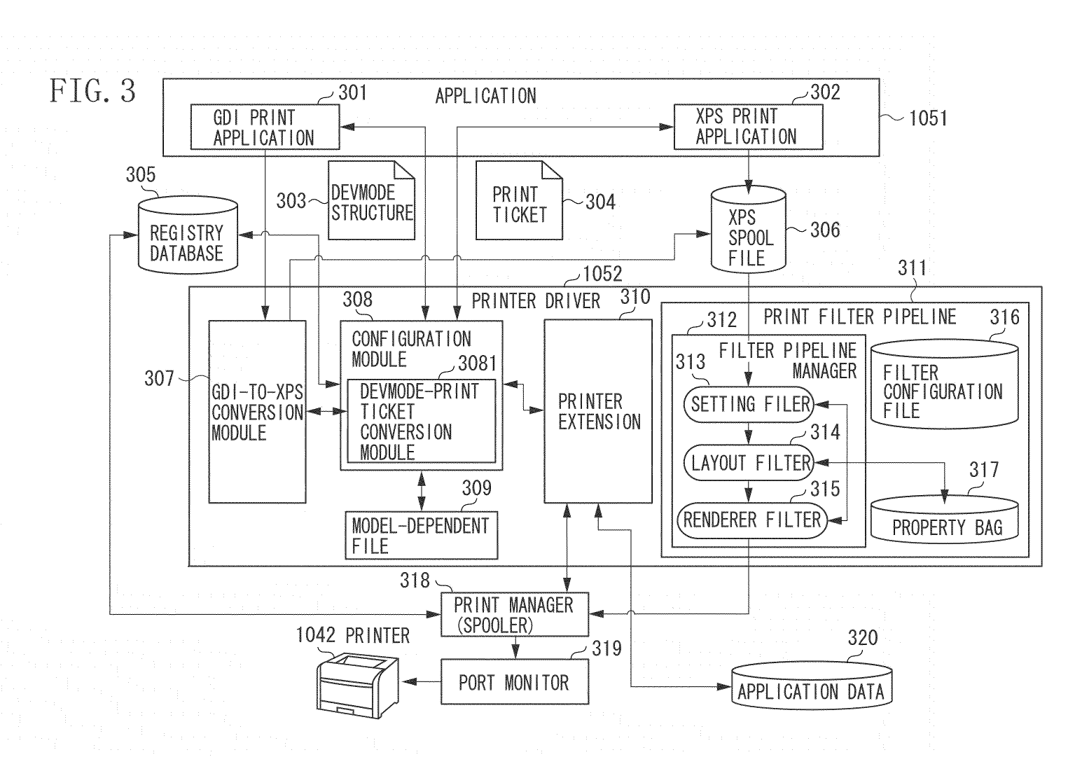

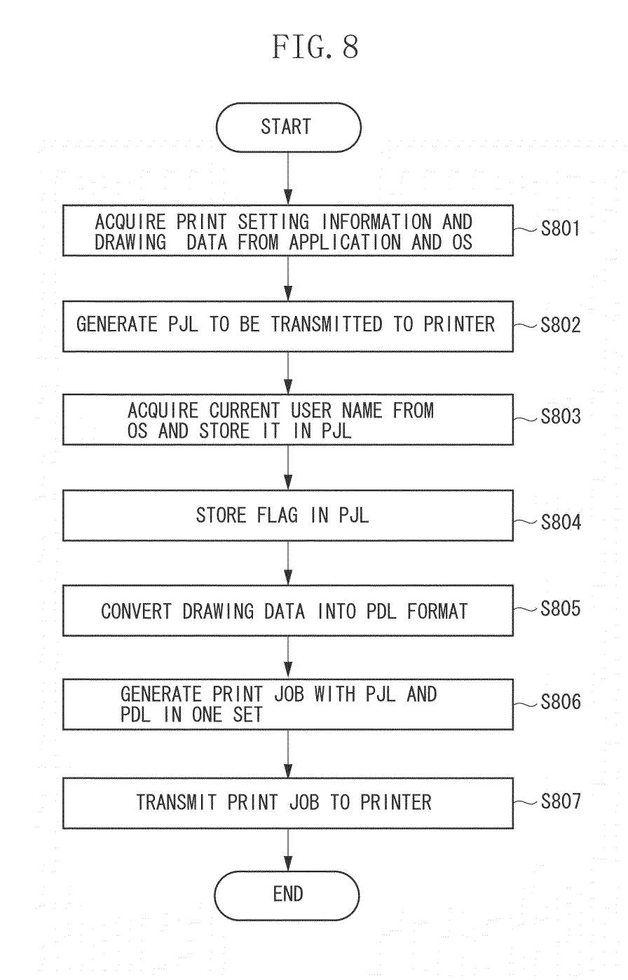

Additionally, the CPU 101 of the client 201 executes processing based on a program stored in the auxiliary storage device 105. This can realize processing performed by a software configuration illustrated in FIG. 3 and performed in each step of flowcharts illustrated in FIGS. 8, 11, 13, and 17 described later.

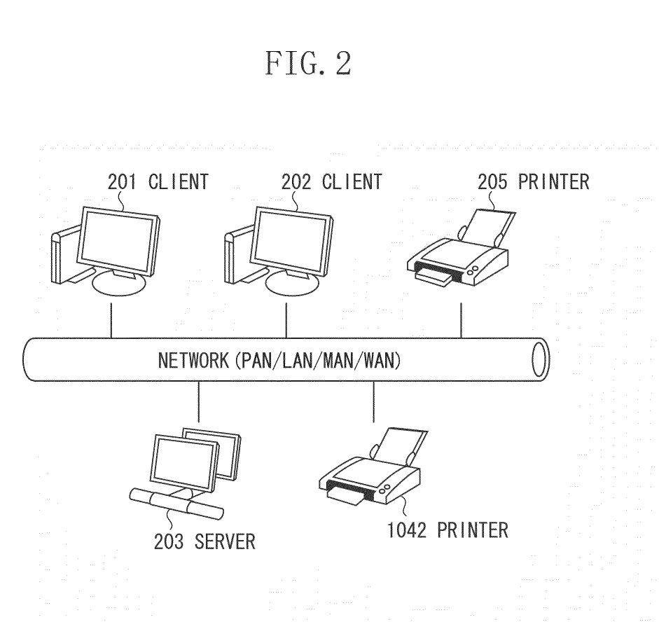

FIG. 2 briefly illustrates an environment of the network 1061 according to the present exemplary embodiment. The clients 201 and 202 which generate a document and an image to be printed is connected to the network 1061. More clients than those illustrated in FIG. 2 may be connected to the network. Further, a client's user or the server 203 managing a printer may be connected. A single or a plurality of printers 1042 is connected to the network 1061. Like a printer 205, even if the printer is physically connected thereto, the printer may be in an off-line state in which the printer cannot be actually used. The network 1061 includes a personal area network (PAN), a local area network (LAN), a metropolitan area network (MAN), and a wide area network (WAN).

FIG. 3 is a block diagram of a v4 driver print system. The v4 driver print system uses a file format called XML paper specification (hereinafter, referred to as “XPS”) as spool data to perform printing. The v4 driver print system operates on the OS 1053. A print manager 318, a graphics device interface (GDI) to XPS conversion module 307, and a filter pipeline manager 312 are modules included in the OS 1053. The GDI-to-XPS conversion module 307 and the filter pipeline manager 312 are included in a printer driver 1052. However, the GDI-to-XPS conversion module 307 and the filter pipeline manager 312 are considered as modules for the printer driver 1052, which are provided by the OS 1053. Each filter of the printer driver 1052 and the filter pipeline manager 312 is stored in the auxiliary storage device 105 illustrated in FIG. 1 as the printer driver 1052.

There are two types of the printer drivers 1052 in this specification, one is for a printer and the other is for fax transmission.

A GDI print application 301 and an XPS print application 302 are stored in the auxiliary storage device 105 illustrated in FIG. 1 as the application 1051. The user uses an input device such as the keyboard 1031 and the pointing device 1032. Further, the user uses the input device to start print processing from a GDI print application 301 (hereinafter, referred to as a “GDI application”) for printing with a GDI or from an XPS print application 302 (hereinafter, referred to as an “XPS application”) for printing with XPS, which are displayed on the monitor 1041 serving as an output device. The print processing is performed by sequentially performing the three types of processing: selecting a printer, generating print settings, and converting a drawing data format. The drawing data described in the specification is image data output from the application and received by the printer 1042 for printing or fax transmission.

A flow of the print processing will be described below.

First, the user selects the printer 1042 to be used for printing. From the user's point of view, selecting the printer 1042 is synonymous with selecting the printer driver 1052 corresponding to the printer 1042 that performs printing. Then the print settings are generated. First, the application 1051 secures a memory region for the print settings in the RAM 1022. The application 1051 invokes a configuration module 308 of the printer driver 1052 to generate and store the print settings. For the print settings, the GDI application 301 uses a binary DEVMODE structure 303, and the XPS application 302 uses a print ticket 304 described in XML, which is a markup language. Since the print ticket 304 describes the print settings in the XML format, it is easy for the XPS application 302 to directly change and rewrite all setting values. However, the settings can also be changed using a user interface of a printer extension 310. Print settings are generated each time a document is to be printed. However, a setting which the user desires to retain, such as setting of an optional device of the printer 1042 or environmental setting for each user is stored by the user interface in a registry database 305 of the OS. When the registry database 305 cannot be used, the user interface stores the setting in application data 320. Default values for the print settings are stored in the registry database 305 by a print manager 318 of the OS. The registry database 305 and the application data 320 are stored in the auxiliary storage device 105. Lastly, the drawing data format is converted. When the print settings have been determined, the user executes print processing from the application. When printing is performed by the GDI application 301, drawing data is transmitted to the GDI-to-XPS conversion module 307, which is in the form of a printer driver, and then is converted into a format of an XPS spool file 306. At this point, the GDI-to-XPS conversion module 307 invokes the configuration module 308 to convert the print settings from the DEVMODE structure 303 to the print ticket 304. The drawing data is converted using a DEVEMODE-print ticket conversion module 3081. When printing is performed by the XPS application 302, two methods are provided. In one method, an XPS file is generated by the XPS application itself. In the other method, the XPS file is generated by the OS according to a drawing direction from the XPS application. In either case, the XPS spool file 306 is generated in the middle of printing. As described above, the v4 driver print system always generates the XPS spool file 306 when printing is performed.

When the XPS spool file 306 has been generated, the file is moved to a print filter pipeline 311 and then processed therein. The print filter pipeline 311 has a mechanism which passes the XPS spool file 306 through a plurality of filters before printing, and controls the number and order of filters using a filter configuration file 316. In the present exemplary embodiment, the filter pipeline manager 312 which operates in the print filter pipeline 311 passes the file sequentially through a setting filter 313, a layout filter 314, and a renderer filter 315 according to the filter configuration file 316. The number and types of filters vary depending on the configuration of the printer driver 1052. The print processing is performed by passing the XPS spool file 306 to such filters, and each filter processes and passes the XPS spool file 306 to the next filter to advance the processing. Finally, a printer control language (hereinafter, referred to as a “page description language (PDL)”), which is a data language that can be interpreted by a printer, is output together with PJL described later. If the printer 1042 is an XPS direct printer that can directly read the XPS spool file 306 to perform printing, all filters can be skipped to perform printing. Filters can store data in a property bag 317. Further, from the property bag 317, information about the OS 1053 and the data of other filters can be acquired. The setting filter 313 performs processing of reading the print ticket 304 and writing the data required for printing into the print ticket 304. The layout filter 314 performs layout-related processing, such as changing a layout scale or processing an imposition layout for bookbinding and a stamp layout. The layout filter 314 operates according to the print ticket 304 included in the XPS spool file 306. Therefore, for example, when the imposition setting is not included in the print ticket 304, the layout filter 314 operates nothing and the XPS spool file 306 is passed to the next filter without being processed. The renderer filter 315, which is the last filter, renders and converts the XPS spool file 306 into PDL. PDL, and PJL described later are managed by the print manager 318 that manages a schedule of the print processing, and print jobs are registered in a queue (waiting line) one after another. When the printer 1042 gets ready for printing, the print jobs registered in a queue are transmitted via a port monitor 319 in a chronological order. As described above, converting the drawing data sent from the application into the PDL format is a main role of the printer driver to perform the print processing.

According to the specification, a fax job is also called a print job.

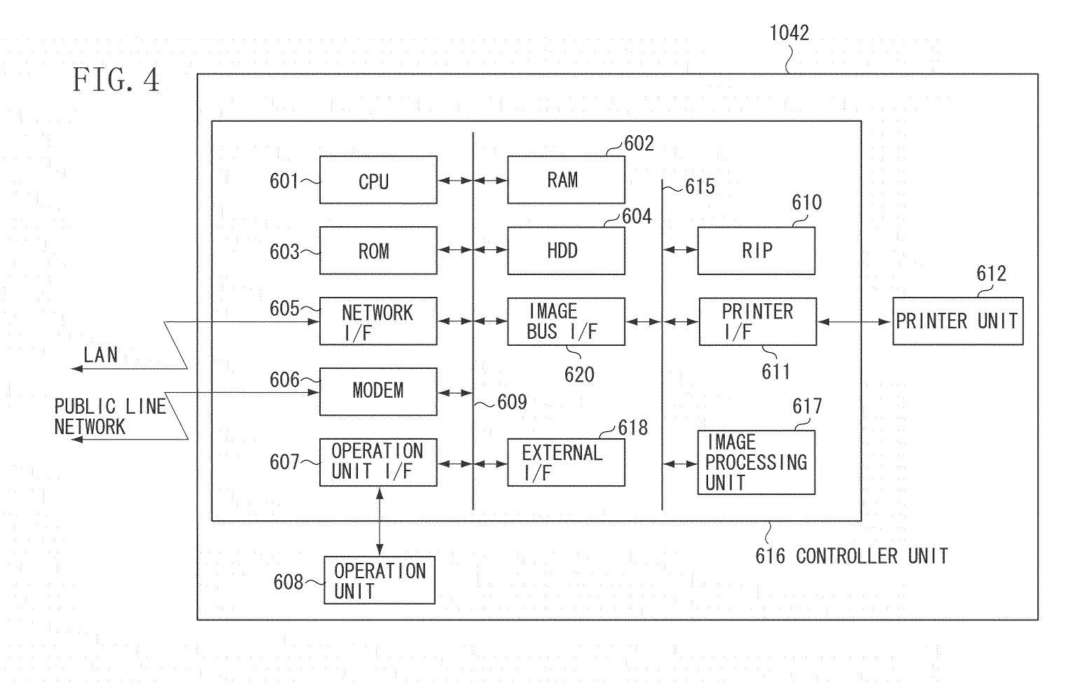

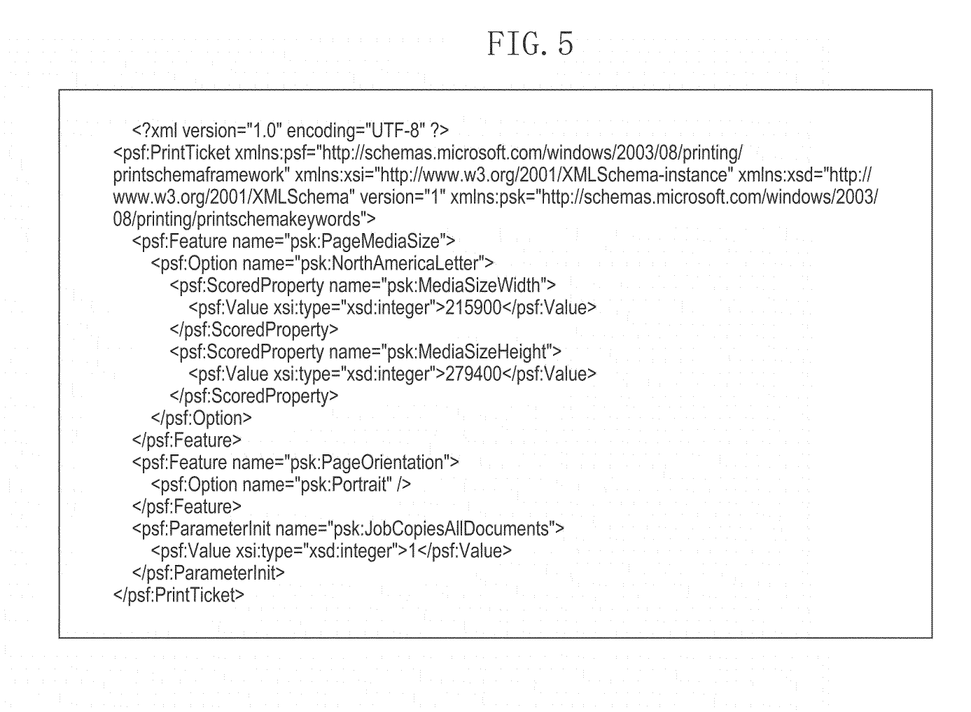

(Configuration of a printing apparatus) FIG. 4 is a block diagram of the printer 1042. As illustrated in FIG. 4, a controller unit 616 is connected to a printer unit 612 serving as an image output device. The controller unit 616 is connected to a network, such as a local area network (LAN) or a wide area network (WAN), to perform input/output of image data or of information about a configuration of a finisher on the printer.

In the specification, the printer 1042, which is literally a printer with the printer unit 612, is used as an example. However, when the printer 1042 performs only fax transmission, the printer 1042 can be configured as a fax device without the printer unit 612.

In the controller unit 616, a CPU 601 is a processor that controls the entire system.

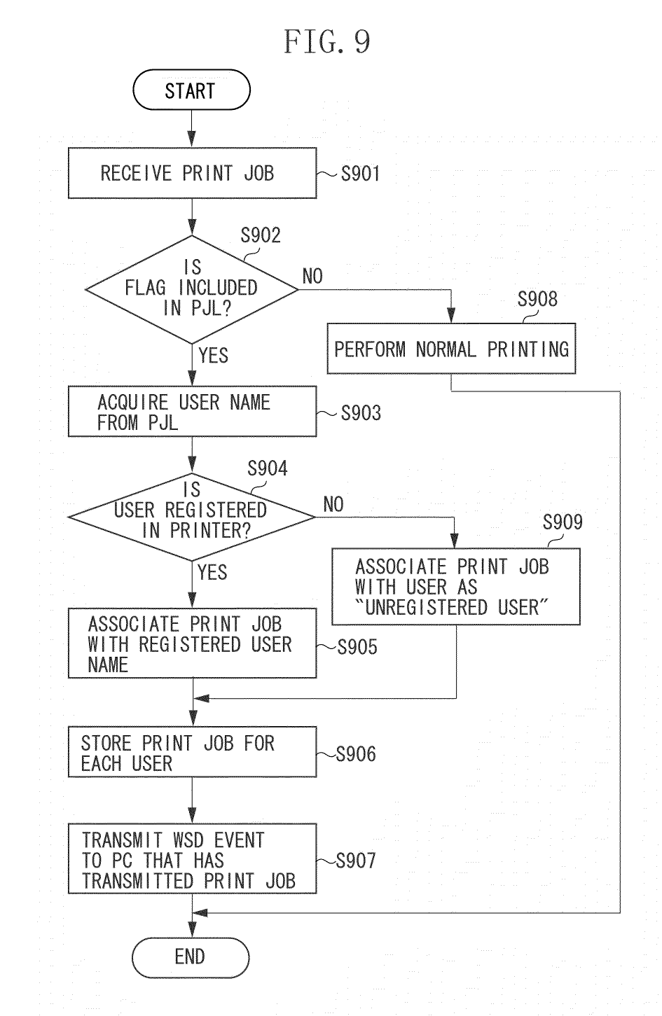

Additionally, the CPU 601 performs processing based on a program stored in a hard disk drive (HDD) 604 described later, so that the processing in each step of the flowcharts illustrated in FIGS. 9, 14, and 19 described later can be realized.

A RAM 602 is used as a system work memory when the CPU 601 operates. The ROM 602 is also used as a program memory for recording programs, and an image memory for temporarily recording image data.

A ROM 603 stores a boot program of the system and various types of control programs.

An HDD 604 stores various types of programs for controlling the system and image data. An operation unit I/F 607 is an interface between the controller unit 616 and an operation unit (UI) 608 and outputs image data to be displayed on the operation unit 608 to the operation unit 608. Further, the operation unit I/F 607 transmits information which is input by the user of the system from the operation unit 608 (e.g., user information) to the CPU 601. The operation unit 608 includes a display unit with a touch panel. When the user presses (touches with a finger) a button displayed on the display unit, the user can provide various types of instructions.

A network I/F 605 is connected to a network to input or output data.

A modem 606 is connected to a public line network to perform input or output of data such as transmission or reception of fax.

An external I/F 618 receives an input from outside, for example, from a universal serial bus (USB), Institute of Electrical and Electronics Engineers (IEEE) 1394, or a printer port.

An image bus I/F 620 is a bus bridge for connecting a system bus 609 to an image bus 615 which transfers image data at a high speed and for converting a data structure. The image bus 615 includes a Peripheral Component Interconnect (PCI) bus or IEEE 1394.

A raster image processor (RIP) 610 expands vector data such as a PDL record into a bit-map image, for example. A printer I/F 611 connects the printer unit 612 to the controller unit 616 and converts from synchronous to asynchronous image data, and vice versa.

An image processing unit 617 corrects, processes, and edits input image data, and also makes a correction to the printer and changes the resolution thereof for output image data to be printed. Further, the image processing unit 617 rotates image data, and performs compression/decompression processing such as joint photographic experts group (JPEG) on multilevel image data, and such as joint bi-level image experts group(JBIG), modified modified read (MMR) and modified huffman (MH) on binary image data.

The printer unit 612 converts raster image data into an image on paper. The printer unit 612 generates a print by employing an electro-photographic method using a photosensitive drum and a photosensitive belt, and an inkjet method for discharging ink from a minute nozzle array to directly print an image on a paper. The printer unit 612 starts a print operation with an instruction from the CPU 601. The printer unit 612 includes a plurality of paper feed stages and the corresponding paper feed cassettes so that different paper sizes or different paper orientations can be selected.

The operation unit 608 includes a liquid crystal display (LCD) display unit, and a touch panel sheet is attached on the LCD to display an operation screen of the system. When a key on the display is pressed, the operation unit 608 transmits positional information to the CPU 601 via the operation unit I/F 607. Further, the operation unit 608 includes various types of operation keys, for example, a start key, a stop key, an identification (ID) key, and a reset key. The start key of the operation unit 608 is used when a reading operation of a document image is started. A center portion of the start key includes a two-color (green and red) light-emitting diode (LED) light, and the color indicates whether the start key is ready for use. Further, the stop key of the operation unit 608 stops the operation in progress. Furthermore, the ID key of the operation unit 608 is used when a user ID of the user is input. The reset key is used when the settings determined via the operation unit 608 are initialized.

A flow for starting printing by the client 201 will be described.

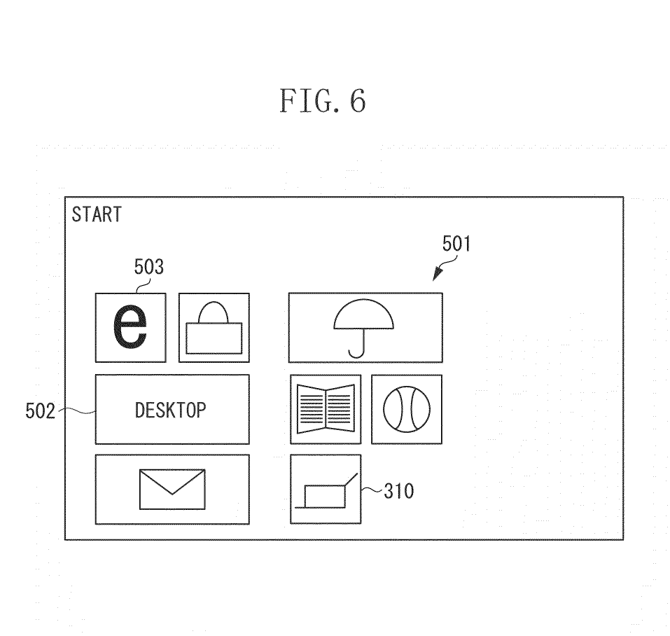

When the client 201 is activated and logged in, a start screen of the OS 1053 illustrated in FIG. 6 is displayed. On the start screen, tiles 501 for activating the application 1051 are arranged, and when the user taps or clicks one of the tiles 501, the application 1051 is activated. Many of the applications 1051 activated here are XPS applications 302, which are optimized for the touch panel displayed on the entire screen. The XPS applications 302 include a web browser 503 described later. The GDI application 301 is activated via a desk top screen appearing by tapping or clicking the tile on a desk top 502. The GDI application 301 can also be registered as a tile on the start screen. Since the printer extension 310 is installed separately from the printer driver 1052, the printer extension 310 can be registered as a tile for an application.

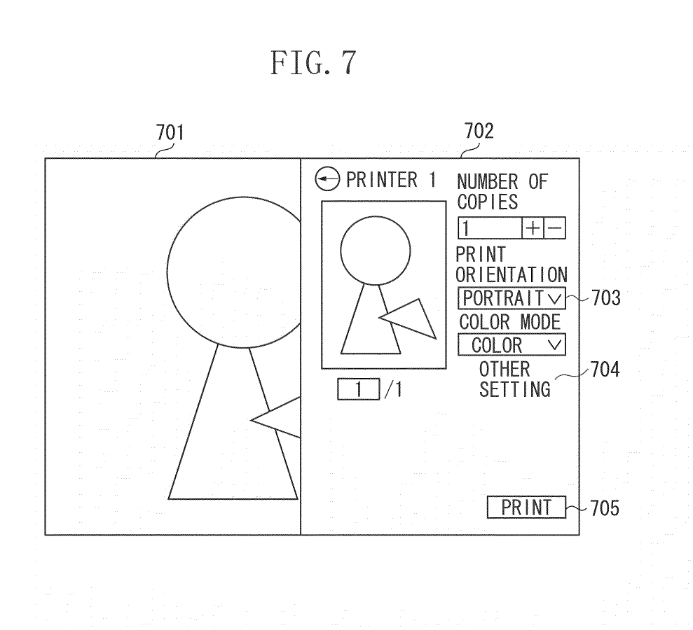

FIG. 7 illustrates a screen of the XPS application 302 activated from the start screen. The entire screen 701 of the application 302 appears on the display, and printing is performed via a print dialog 702 prepared by the OS 1053. The print dialog 702 is invoked on the application screen to set print settings with a control 703 for each setting. When the user taps or clicks a link for other setting 704, a user interface of the printer extension 310 appears. On the user interface of the printer extension 310, print settings can be set in more details. After print settings are set, a print button 705 is tapped or clicked to start printing.

According to the flowcharts illustrated in FIGS. 8, 9, 11, and 13, a flow of a fax operation in the present exemplary embodiment will be described.

FIG. 8 is a flowchart illustrating the printing performed by the printer driver 1052. When the printing is started, in step S801, the printer driver 1052 acquires print setting information and drawing data from the application 1051 and the OS 1053.

In step S802, the printer driver 1052 generates the print setting information to be transmitted to the printer 1042 based on the acquired print setting information.

A PJL language is used for print setting information to be transmitted to the printer. According to the specification, a storage including a description in PJL is also referred to as PJL. In step S803, the printer driver 1052 acquires from the OS 1053 a user name that currently logs in, and stores the user name in PJL.

According to the exemplary embodiment, since the printer driver 1052 designed for fax is used, the input of a fax address (telephone number) is required to complete the printing. In step S804, the printer driver 1052 stores in PJL a flag indicating that an event prompting the user to input an address (hereinafter, simply referred to as a “flag”) is transmitted from the printer 1042.

Then, in step S805, the printer driver 1052 converts the acquired drawing data into the PDL format.

When PDL is generated, in step S806, the printer driver 1052 generates the print job with PJL and PDL in one set and, in step S807, transmits the print job to the printer.

In such a manner, the print job is transmitted to the printer 1042.

FIG. 9 is a flowchart illustrating the operation of the printer 1042 receiving the print job transmitted from the printer driver 1052. In step S901, the printer 1042 receives the print job.

In step S902, the printer 1042 takes PJL from the print job and determines whether a flag is included in PJL.

When a flag is not included (NO in step S902), then in step S908, the printer 1042 performs normal print processing.

When a flag is included (YES in step S902), then in step S903, the printer 1042 acquires the user name in PJL.

In step S904, the printer 1042 checks whether the user name in PJL is included in a list of registered user names.

The printer 1042 according to the specification performs account management. The printer 1042 stores a list of registered user names in an auxiliary storage device (HDD 604). Or, the printer 1042 can be configured to inquire of the server 203 about a list of registered user names.

When the user name is registered (YES in step S904), then in step S905, the printer 1042 associates the print job with the registered user name.

When the user name is not registered (NO in step S904), then in step S909, the printer 1042 associates the print job with an “unregistered user name”.

In step S906, the printer 1042 stores the associated print job in the own HDD 604 for each user.

In step S907, the printer 1042 uses Web Services on Devices (WSD) to transmit a job status event to the computer that has transmitted the print job.

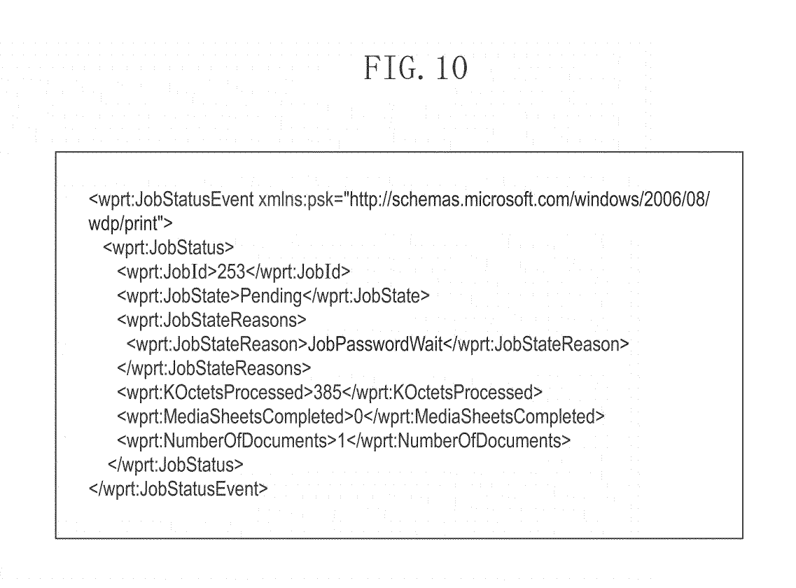

With reference to FIG. 10, the job status event transmitted in step S907 will be described in detail. An event to be transmitted in the WSD is data in XML format. “Job Password Wait” is written in the “Job State Reasons” element of the “Job Status Event”. The “Job Password Wait” herein indicates that the printer 1042 is waiting for password input.

The specification describes an example in which the event is transmitted using WSD, however, when a unique event can be transmitted by a technique other than WSD, the unique event, in place of the job status event, may be transmitted.

The event transmitted from the printer 1042 is transmitted from the print manager 318 to the printer extension 310 via the port monitor 319. A model-dependent file 309 describes which event is transmitted to the printer extension 310.

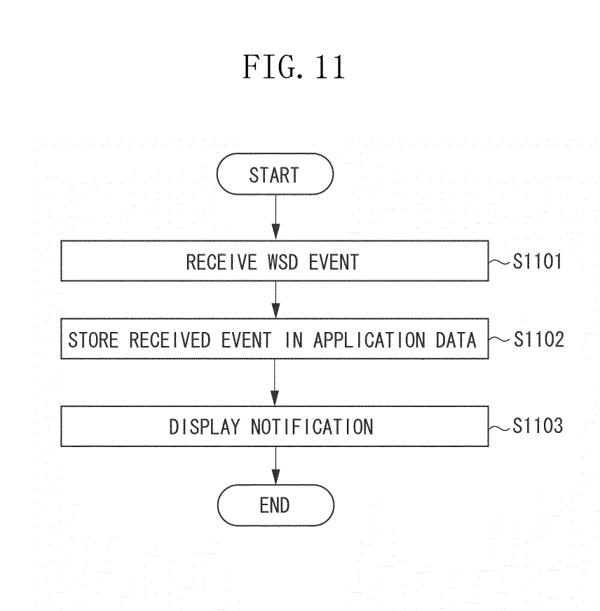

FIG. 11 is a flowchart illustrating the operation of the printer extension 310 that acquires the event transmitted from the printer 1042.

In step S1101, the printer extension 310 receives the WSD event transmitted from the printer 1042.

In step S1102, the printer extension 310 stores the XML data of the received event in the application data 320.

In step S1103, the printer extension 310 invokes a notification 1201, which is a function of the OS 1053, and displays the notification 1201 to inform the user that the event has arrived. Then, the printer extension 310 is ended.

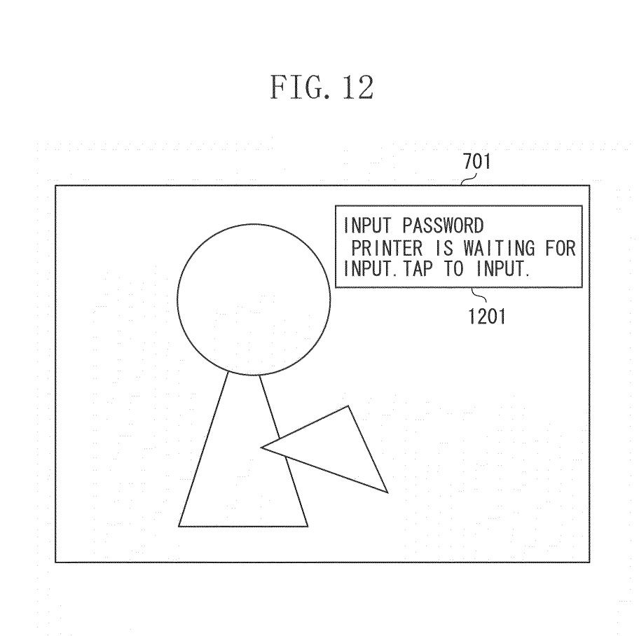

As illustrated in FIG. 12, the notification 1201 is displayed on the entire screen 701 of the application, and the user can restart the printer extension 310 by tapping or clicking the notification 1201.

The notification 1201 disappears when a predetermined period of time elapses. However, the user can actively activate the printer extension 310 by tapping or clicking the tile 501.

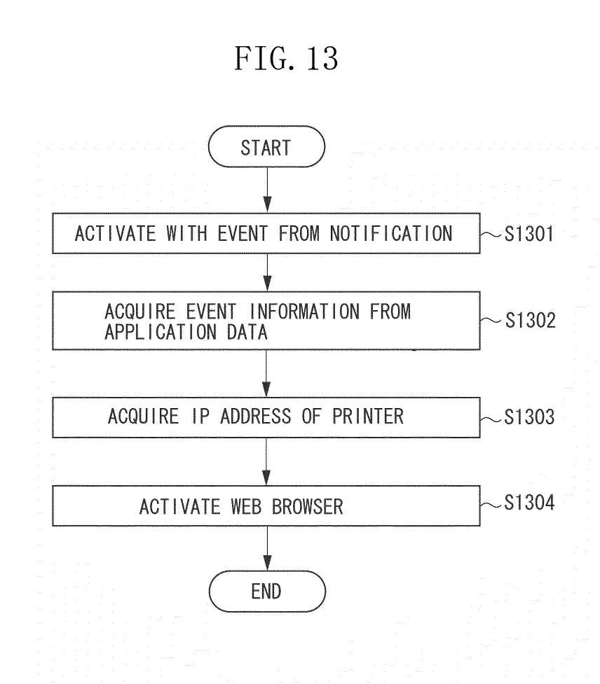

FIG. 13 is a flowchart illustrating the operation of the printer extension 310 activated by tapping the notification 1201. In step S1301, when the user taps the notification 1201, the printer extension 310 is activated by the OS 1053. At this point, an instance of the port monitor 319 corresponding to the printer 1042 that has transmitted the notification transmits an event to the printer extension 310.

In step S1302, the printer extension 310 acquires the XML data of the WSD event from the application data 320.

When the printer extension 310 determines that “Job Password Wait” is specified in the “Job State Reasons” element, then in step S1303, an internet protocol (IP) address of the printer 1042 is acquired from the port monitor 319. The IP address is already obtained by the instance of the port monitor 319 corresponding to the printer 1042 in step S1301.

Or, in step S907 illustrated in FIG. 9, the event of the printer 1042 may be transmitted with an address of the printer 1042, and the transmitted address may be acquired by the printer extension 310 in step S1303.

The specification describes an example in which the printer 1042 is identified with the IP address. However a network address describing a name (domain name or host name) may be used.

This is realized using an application programmable interface (API) of the OS 1053 referred to as Bidi. In step S1304, the printer extension 310 activates the web browser 503 and connects thereto using the acquired IP address of the printer 1042 as a uniform resource locator (UR).

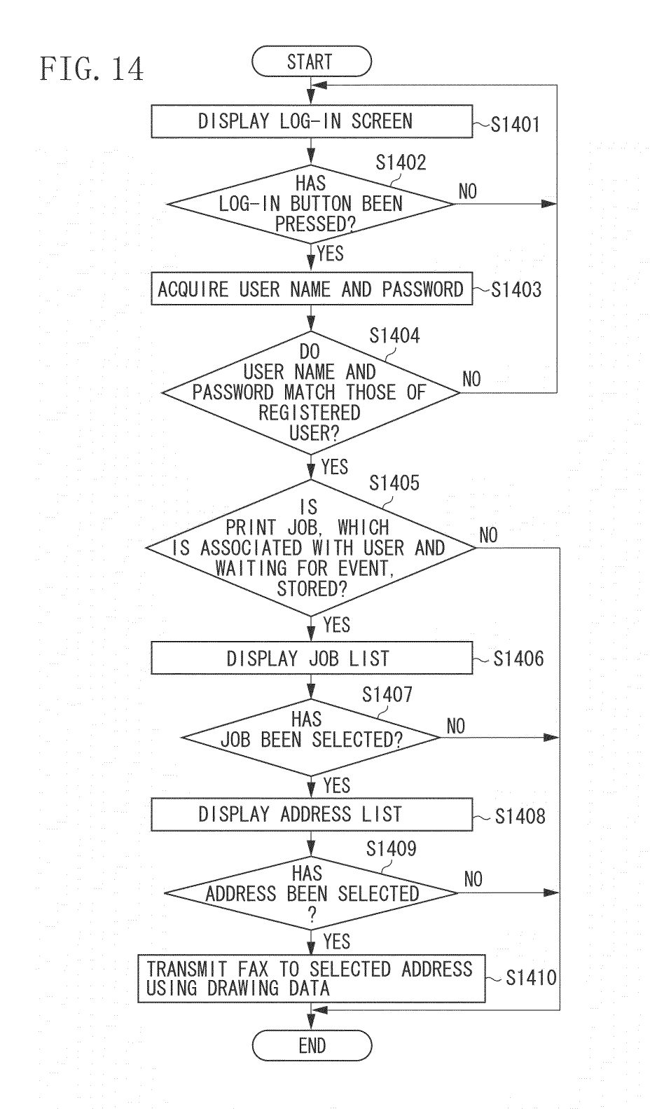

FIG. 14 is a flowchart illustrating the operation of the printer 1042 connected via the web browser 503 of the client 201.

In step S1401, the printer 1042 transmits to the web browser 503 information necessary for the web browser 503 to display a log-in screen.

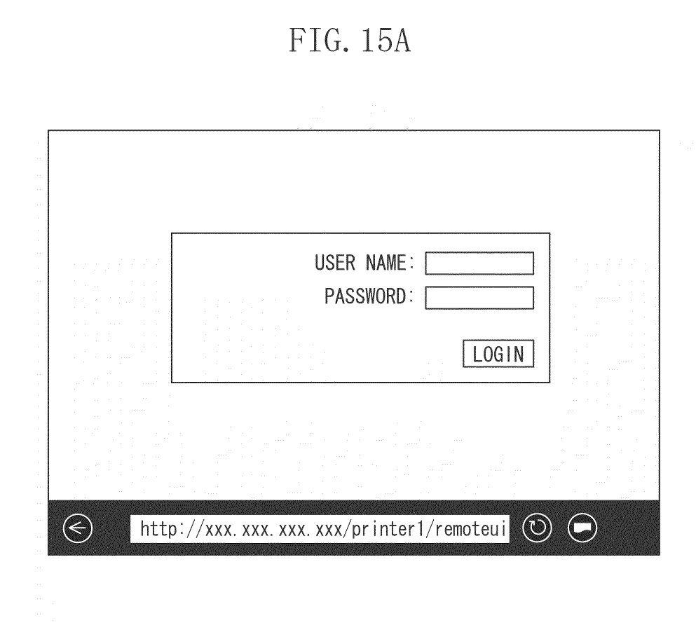

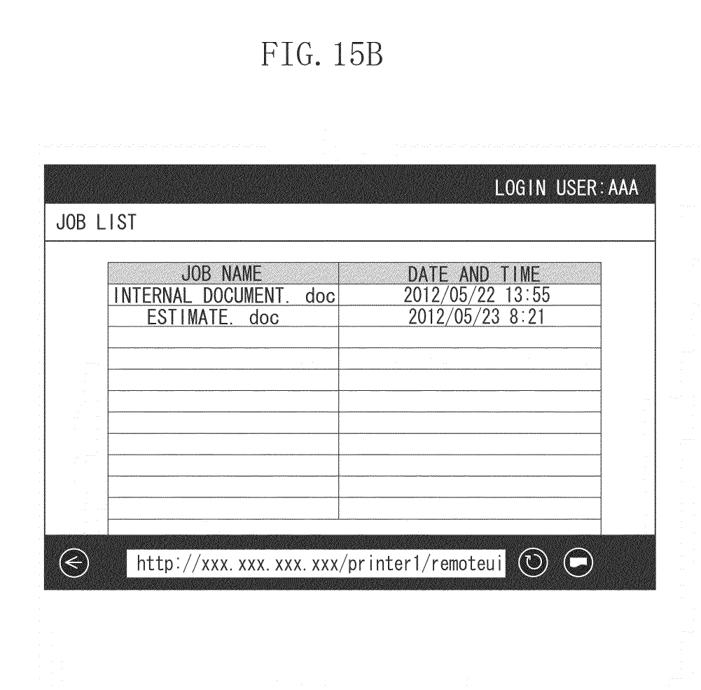

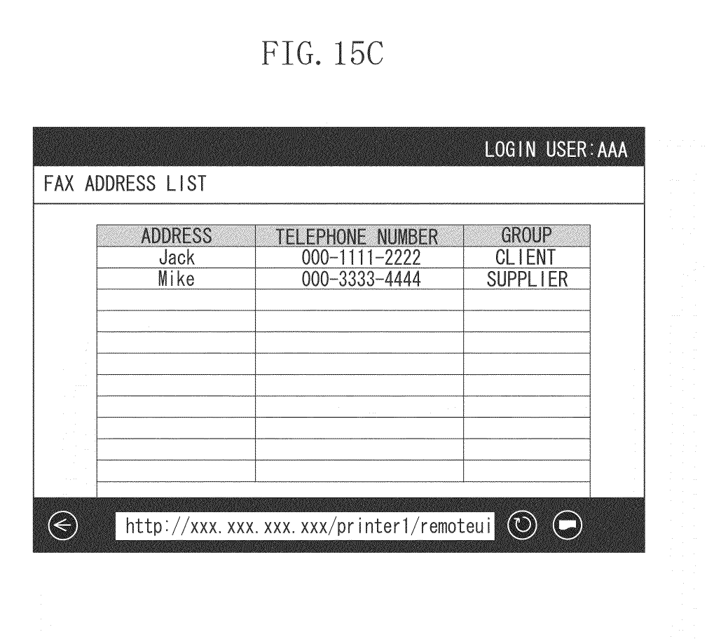

FIG. 15A is a log-in screen displayed via the web browser 503. The user inputs the user name and the password and then presses a log-in button to proceed. When the printer 1042 determines that the log-in button is pressed (YES in step S1402), then in step S1403, the user name and the password input by the user are acquired.

When it is determined that the user is not registered in the printer 1042 in step S904 illustrated in FIG. 9, the information for displaying a message for an unregistered user on the screen illustrated in FIG. 15A may be transmitted to the client computer 201. The message may include “when a user is not registered, request a manager to register the user” or “request a registered user to perform fax transmission or printing”.

Further, when the user who has not been registered in the printer 1042 is registered after the message is viewed, the processing in step S905 may be performed triggered by the user registration. At this point, association of the print job with the “unregistered user” performed in step S909 may be cancelled. This can prevent, after the user registration, any user other than the registered user from viewing the print job.

In step S1404, the printer 1042 determines whether the user name and password acquired respectively match those of the registered user. In place of determination by the printer 1042 itself, the user name and the password may be transmitted to the server 203 so that the printer 1042 receives an authentication result from the server 203.

When the above-described user names and passwords do not match each other respectively (NO in step S1404), the printer 1042 returns to the log-in screen. When the printer 1042 determines that the acquired user name and password respectively match those of the registered user (YES in step S1404), then in step S1405, the printer 1042 determines whether a print job that is associated with the user name and waits for an event is stored. At this point, the printer 1042 also determines whether a print job that is associated with an “unregistered user” and waits for an event is stored.

When the printer 1042 determines that such a print job is stored (YES in step S1405), then in step S1406, a list of stored print jobs is transmitted to the web browser 503.

FIG. 15B illustrates a job list displayed on the screen of the web browser 503. Whether to display a stored print job of an “unregistered user” depends on the setting of the printer 1042. A print job of an “unregistered user” may be separately displayed so that a print job of an “unregistered user” can be identified.

In step S1407, when the printer 1042 determines that a print job is selected by the user (YES in step S1407), then in step S1408, an address list is transmitted to the web browser 503.

The printer 1042 has a fax address list related to the user registered therein. FIG. 15C illustrates the address list displayed on the screen of the web browser 503. An address selected from the address list is the user input information according to the present exemplary embodiment. The user selects an address on the screen of the web browser 503 of the client 201, and the client 201 transmits the user input information to the printer 1042, so that the printer 1042 receives the user input information corresponding to the drawing data of the print job.

In step S1409, when the printer 1042 determines whether the user has selected an address (YES in step S1409), then in step S1410, the printer 1042 uses the drawing data of the print job to transmit a fax data to the selected address.

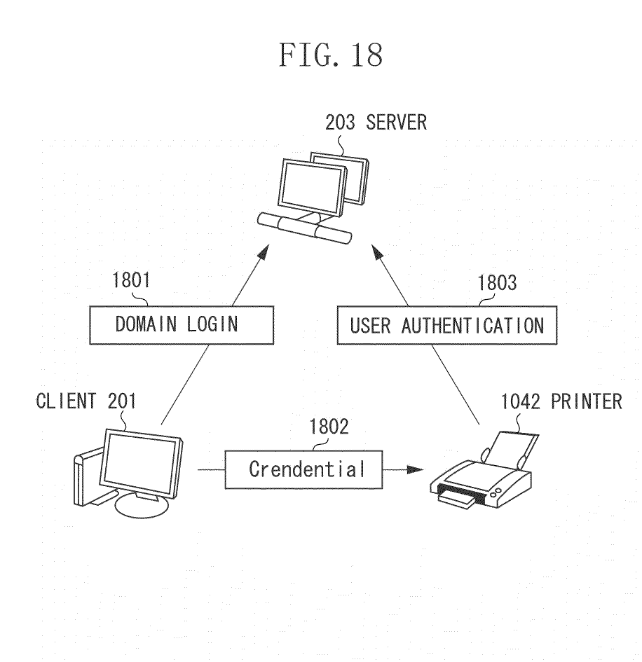

In the flowchart illustrated in FIG. 14, the login process can be omitted by using a single sign-on system. FIG. 18 illustrates a single sign-on system. When the user logs in the OS 1053 of the client 201 joining a domain of the server 203, the user is authenticated by the server 203 as a domain log-on 1801. When the client 201 is connected to the printer 1042 via the web browser 503, the client 201 transmits a credential 1802, which is authentication information, to the printer 1042. When the printer 1042 receives the credential 1802, the printer 1042 performs user authentication 1803 with the server 203 to check which user has transmitted credential 1802. In such a manner, a single sign-on system does not require input of the user name and the password for login via the web browser 503, so that the flowchart illustrated in FIG. 14 can be started at step S1404.

If the user does not tap or click the notification 1201 and does nothing, the print job remains stored in the printer 1042. Connecting to the web page for the printer 1042 allows the user to continue printing from the operation in the flowchart illustrated in FIG. 14. Or, the user may log in via the panel of the printer 1042 to perform the flowchart illustrated in FIG. 14 on the printer 1042. Or, when the user logs in via the panel, in place of the credential 1802, a noncontact IC card may be touched over the printer 1042. Based on the information stored in the noncontact IC card, the printer 1042 performs authentication to the server 203, so that a single sign-on can be realized without using the web browser 503.

As described above, the printer driver 1052 transmits a print job, the printer 1042 provides a notification using an event, and then the printer driver 1052 connects to the printer 1042 via the web browser 503, so that input of an fax address is ensured each time printing is performed. Further, since the fax address list of the printer 1042 can be used, selecting an address does not require the printer driver 1052 to communicate with the printer 1042.

According to the specification, the web browser 503 is used to connect to the printer 1042. However, in place of the web browser 503, a dedicated application for connecting to the printer 1042 may be prepared. In this case, the dedicated application is invoked by the printer extension 310 to connect to the printer 1042.

A second exemplary embodiment of the present invention will be described below. The present exemplary embodiment can be applied to, in addition to fax transmission, confidential printing and authentication printing used for department management, for example. An exemplary embodiment of confidential printing will be described below.

In the present exemplary embodiment, the printer 1042 does not need to have a function of fax transmission.

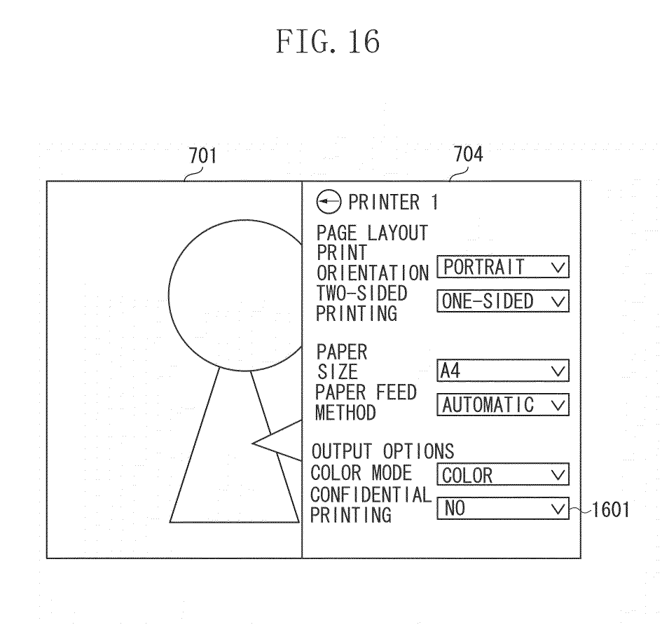

In the present exemplary embodiment, when print settings are made as illustrated in FIG. 7, and when the user taps or clicks other setting 704, the OS 1053 displays the user interface screen of the printer extension 310. FIG. 16 illustrates the user interface screen of the printer extension 310. On the user interface illustrated in FIG. 16, the user selects confidential printing 1601, changes the print setting to “yes”, and then returns to the original print dialog 702. The printer extension 310 stores the setting for the confidential printing 1601 as print setting information.

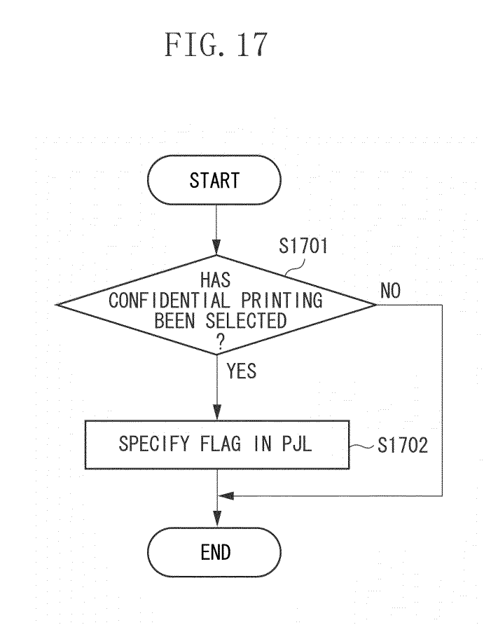

According to the present exemplary embodiment, when a flag is included in PJL in step S804 in the flowchart illustrated in FIG. 8, it is determined whether the confidential printing 1601 has been selected, as illustrated in the flowchart in FIG. 17. In step S1701, the printer driver 1052 determines whether “yes” is selected for the confidential printing 1601 as the print setting.

When the printer driver 1052 determines that “yes” is selected for the confidential printing 1601 (YES in step S1701), then in step S1702, the printer driver 1052 specifies a flag in PJL.

When “no” is selected for the confidential printing 1601 (NO in step S1701), the printer driver 1052 does not specify a flag in PJL. When a flag is not included in PJL, the printer 1042 performs normal printing in step S902 in the flowchart illustrated in FIG. 9.

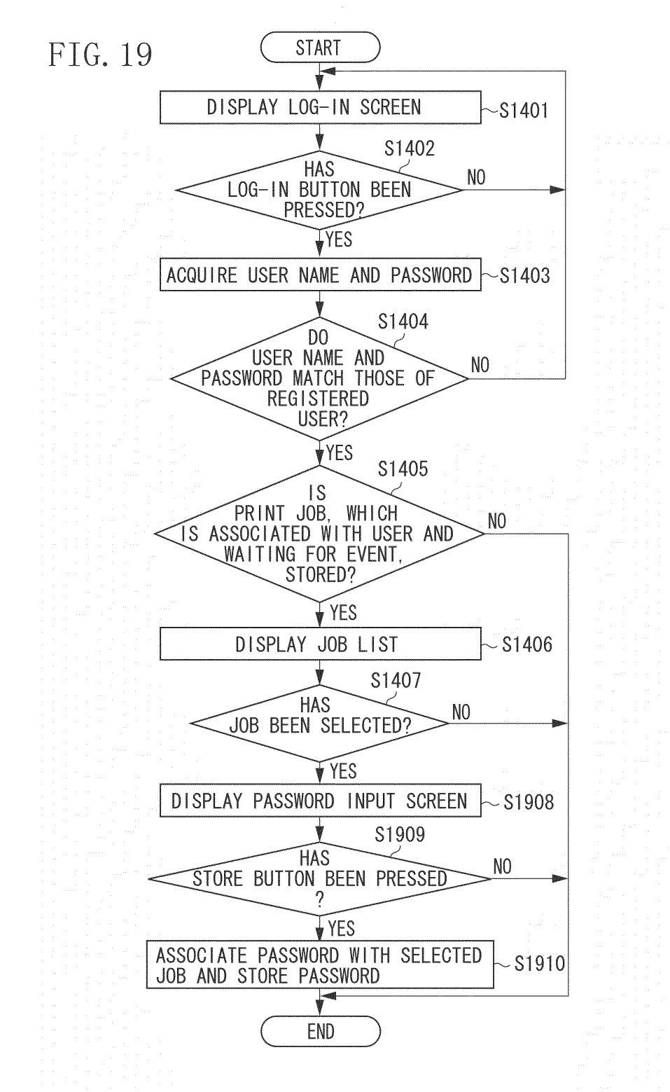

Next, in place of the flowchart illustrated in FIG. 14 according to the present exemplary embodiment, the operation of confidential printing performed by the printer 1042 connected via the web browser 503 will be described with reference to the flowchart illustrated in FIG. 19. For the same processing as that in the steps described above, the same reference numerals as those in the steps described above are given and, unless otherwise specified, the description of the same processing will be omitted.

When the printer 1042 determines that the user selects a print job (YES in step S1407), then in step S1908, the printer 1042 displays a password input screen.

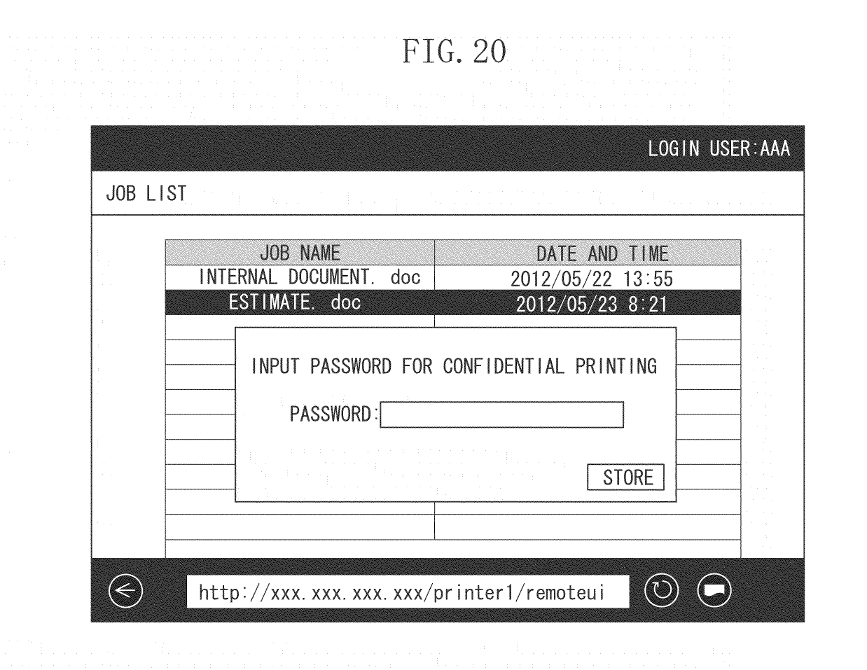

FIG. 20 illustrates the password input screen displayed via the web browser 503. The user inputs the password, and presses a “store” button. When department management printing is performed, in place of the password input screen, a screen for inputting department management information is displayed.

In step S1909, when the “store” button is pressed (YES in step S1909), then in step S1910, the printer 1042 associates the password with the selected print job and stores the password. When department management printing is performed, in place of the password, the department management information is associated with the print job. The department management information and the print job that are associated with each other are stored as a log. Or, the printer 1042 may generate attribute information including the number of pages from the print job, and may associate the generated attribute information with the department management information to store the information associated with each other as a log.

In the present exemplary embodiment, the password input on the screen displayed in step S1908 is user input information. On the screen of the web browser 503 of the client 201, the user inputs the password and the client 201 transmits the user input information to the printer 1042, so that the printer 1042 receives the user input information corresponding to the drawing data of the print job.

The user uses the panel of the printer 1042 to request the display of a print job list and selects a print job to be printed from a list of print jobs on the display, and then a password screen for confidential printing appears. The user uses the panel and a ten-key numeric keypad of the printer 1042 to input the password that has been input via the screen displayed in step S1908 and then perform printing, so that a print cannot be taken away by others, and printing can be securely performed

When department management printing is performed, in place of performing the above-described authentication, the printing may be started when the printer 1042 receives a print job.

As described above, a method in which the printer 1042 transmits an event for notification and then is connected via the web browser 503 can be applied to even authentication printing such as confidential printing. This allows even the OS 1053 that cannot display a user interface when printing is performed to perform authentication printing by causing the user to input the password.

Further, the exemplary embodiment of the present invention can be realized by performing the processing described below.

Software (program) that realizes the functions of the above-described exemplary embodiments is supplied to a system or an apparatus via a network or various types of storage mediums, and a computer (for example, CPU or a micro processing unit (MPU)) of the system or the apparatus reads the program to perform the processing.

Even when an information processing apparatus alone cannot prompt the user to voluntarily input user input information when the apparatus performs output based on drawing data, the apparatus can prompt the user to input user input information by acquiring a notification from a device.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and function.

This application claims the benefit of Japanese Patent Application No. 2012-258558 filed Nov. 27, 2012, which is hereby incorporated by reference herein in its entirety.

What is claimed is:

1. A device comprising:
a notification unit configured to notify an information processing apparatus of an execution instruction for accessing the device;
a reception unit configured to receive a fax address corresponding to drawing data from the information processing apparatus as a response to the notification of the execution instruction by the notification unit; and
a transmission unit configured to transmit a fax data based on the fax address and the drawing data.

2. The device according to claim 1, wherein the device transmits, after the notification of the execution instruction, information for causing the information processing apparatus to display, by accessing the device, an input screen for receiving an input of a fax address from a user, and then to transmit to the device the fax address that is input via the input screen and corresponds to the drawing data.

3. The device according to claim 1, further comprising an operation unit, wherein the reception unit is further configured to receive the fax address from the operation unit of the device.

4. An information processing system including a device and an information processing apparatus, the information processing apparatus comprising:
a first transmission unit configured to transmit drawing data; and
a reception unit configured to receive from the device an execution instruction for accessing the device,
wherein the information processing apparatus displays by accessing the device an input screen for receiving an input of a fax address from a user, and
wherein the information processing apparatus transmits to the device the fax address that is input via the input screen and corresponds to the drawing data, and the device comprising:
a notification unit configured to notify the information processing apparatus of the execution instruction for accessing the device,
a reception unit configured to receive the fax address corresponding to the drawing data from the information processing apparatus as a response to the notification of the execution instruction by the notification unit, and
a second transmission unit configured to transmit a fax data based on the fax address and the drawing data.

5. The information processing system according to claim 4, wherein the second transmission unit transmits to the device the drawing data based on a print setting except for the fax address.

6. The information processing system according to claim 4, wherein the information processing apparatus further comprises an acquisition unit configured to acquire a fax job stored in the device, and
wherein the information processing apparatus displays the input screen for receiving from the user an input of an address for the fax job acquired by the acquisition unit.

7. The information processing system according to claim 4, wherein the information processing apparatus further comprises a second acquisition unit configured to acquire an address of the device after the reception unit receives the execution instruction.

8. The information processing system according to claim 4, wherein the information processing apparatus displays the input screen by opening an address of the device via a browser.

9. The information processing system according to claim 4, wherein the information processing apparatus hides a notification screen for displaying the input screen after the notification screen is displayed for a predetermined time.

10. A control method for a device, the control method comprising:
notifying an information processing apparatus of an execution instruction for accessing the device,
receiving a fax address corresponding to drawing data from the information processing apparatus as a response to the notification of the execution instruction, and
transmitting a fax data based on the fax address and the drawing data.

11. The control method according to claim 10, further comprising transmitting, after the notification of the execution instruction, information for causing the information processing apparatus to display, by accessing the device, an input screen for receiving an input of a fax address from a user, and then to transmit to the device the fax address that is input via the input screen and corresponds to the drawing data.

12. The control method according to claim 10, further comprising receiving the fax address from an operation unit of the device.

13. A control method for a system including a device and an information processing apparatus, the control method comprising:
transmitting drawing data;
receiving from the device an execution instruction for accessing the device;
displaying by accessing the device an input screen for receiving an input of a fax address from a user;
transmitting to the device the fax address that is input via the input screen and corresponds to the drawing data and;
notifying the information processing apparatus of the execution instruction for accessing the device;
receiving the fax address corresponding to the drawing data from the information processing apparatus as a response to the notification of the execution instruction; and
transmitting a fax data based on the fax address and the drawing data.

14. The control method according to claim 13, further comprising transmitting to the device the drawing data based on a print setting except for the fax address.

15. The control method according to claim 13, further comprising acquiring a fax job stored in the device, wherein the information processing apparatus displays the input screen for receiving, from the user, an input of an address for the acquired fax job.

16. The control method according to claim 13, further comprising acquiring an address of the device after the execution instruction is received.

17. The control method according to claim 13, wherein the information processing apparatus displays the input screen by opening an address of the device via a browser.

18. The control method according to claim 13, wherein the information processing apparatus hides a notification screen for displaying the input screen after the notification screen is displayed for a predetermined time.
